(19) United States
(12) Patent Application Publication
(10) Pub. No.: US 2026/0010240 A1
(43) Pub. Date: Jan. 8, 2026

(54) BUTTON INPUT STRUCTURE WITH MECHANICAL SWITCHES AND STRAIN-BASED SENSORS

(71) Applicant: Qorvo US, Inc., Greensboro, NC (US)

(72) Inventors: Bryan Low, San Mateo, CA (US); Julius Minglin Tsai, San Jose, CA (US); Omar Leung, Palo Alto, CA (US)

(21) Appl. No.: 19/257,678

(22) Filed: Jul. 2, 2025

Related U.S. Application Data
(60) Provisional application No. 63/667,337, filed on Jul. 3, 2024.
(60) Provisional application No. 63/725,687, filed on Nov. 27, 2024.

(51) Int. Cl. G06F 3/02; G01L 1/22

(52) U.S. Cl. CPC G06F 3/0202; G01L 1/225

(57) ABSTRACT

The present disclosure relates to a button input structure of an electronic device, which can achieve a binary function and detect an external force applied to the button input structure. The disclosed button input structure includes a button component, mechanical switches, strain-based sensors, a substrate underneath the button component to accommodate the mechanical switches and the strain-based sensors, and a holding basket configured to provide mechanical support to the substrate, the strain-based sensors, the mechanical switches, and the button component. Herein, depression of the button component caused by the external force can produce strain on the substrate. Each of the strain-based sensors attached to the substrate is configured to detect the external force applied to the button component by sensing the strain on the substrate and configured to provide an output indicating information of a touch point of the external force and an amount of the external force.

### RELATED APPLICATIONS

This application claims the benefit of provisional patent application Ser. No. 63/667,337, filed Jul. 3, 2024, and provisional patent application Ser. No. 63/725,687, filed Nov. 27, 2024, the disclosures of which are hereby incorporated herein by reference in their entireties.

### FIELD OF THE DISCLOSURE

The present disclosure relates to a button input structure of an electronic device, and more particularly to a button input structure including two or more mechanical switches to achieve a binary function and two or more strain-based sensors to detect an external force applied to the button input structure.

### BACKGROUND

With the popularity of portable electronic products in both consumer and military applications, it is highly desired to implement more functions into electronic devices without increasing the size of the electronic devices, so as to achieve highly compact integration of diverse components and functionalities.

Button components are widely used in input structures of electronic devices, such as mobile devices and the like. Conventional button implementations on mobile devices, or other electronic devices are typically coupled with mechanical switches to perform a binary function, so as to achieve ON/OFF or UP/DOWN operations in the electronic devices. In order to further utilize the button components in the electronic devices, there still remains a need for improved input structure designs, which are capable of achieving a binary function as well as a sliding function that utilizes the position and intensity of force/pressure applied to the button component without disrupting an overall architecture of the electronic device. By detecting the position and intensity of force/pressure applied to the button component, the electronic device is capable of performing other operations (such as performing a digital movement on a display) in addition to the ON/OFF or UP/DOWN operations based on the binary function.

### SUMMARY

The present disclosure relates to a button input structure of an electronic device, which is capable of achieving a binary function and detecting an external force applied to the button input structure. The disclosed button input structure includes a button component, mechanical switches, strain-based sensors, at least one substrate underneath the button component to accommodate the mechanical switches and the strain-based sensors, and a holding basket, which is configured to provide mechanical support to the at least one substrate, the strain-based sensors, the mechanical switches, and the button component. Herein, the button component, the mechanical switches, the at least one substrate, and the holding basket are mechanically connected, such that depression of the button component caused by an external force applied to the button component is capable of producing strain on the at least one substrate. Each of the strain-based sensors is attached to the at least one substrate and configured to detect the external force applied to the button component by sensing the strain on the at least one substrate and configured to provide an output indicating information of a touch point of the external force and an amount of the external force.

In one embodiment of the button input structure, the at least one substrate is formed of a first spring-like material, and the holding basket is formed of a second spring-like material.

In one embodiment of the button input structure, the first spring-like material is stainless steel or alloy steel, and the second spring-like material is stainless steel or alloy steel.

According to one embodiment, the button input structure further includes a first part of a housing of the electronic device. Herein, the first part of the housing includes an opening. The holding basket is adhered to the first part of the housing and underneath the opening to provide an air chamber connected to the opening. The button component extends through the opening and into the air chamber without adhering to the first part of the housing.

In one embodiment of the button input structure, the holding basket includes a base plate and a basket arm that extends from the base plate and is adhered to the first part of the housing, so as to hold the base plate. The air chamber is above the base plate and surrounded by the basket arm.

In one embodiment of the button input structure, a bottom surface of the at least one substrate is adhered to a top surface of the base plate. The mechanical switches are attached to a top surface of the at least one substrate, and the button component sits on the mechanical switches. The strain-based sensors are attached to the bottom surface of the at least one substrate, and the base plate of the holding basket includes individual holes to accommodate the strain-based sensors, respectively.

In one embodiment of the button input structure, the at least one substrate includes at least a first substrate and a second substrate separate from the first substrate. A bottom surface of the first substrate and a bottom surface of the second substrate are adhered to the top surface of the base plate. At least one of the mechanical switches is attached to a top surface of the first substrate, and at least another one of the mechanical switches is attached to a top surface of the second substrate. The button component sits on the mechanical switches. At least one of the strain-based sensors is attached to the bottom surface of the first substrate, and at least another one of the strain-based sensors is attached to the bottom surface of the second substrate. The base plate includes individual holes to accommodate the strain-based sensors, respectively.

In one embodiment of the button input structure, the at least one substrate is adhered to the top surface of the base plate. The mechanical switches are attached to a top surface of the at least one substrate, and the button component sits on the mechanical switches. The strain-based sensors are attached to the top surface of the at least one substrate without contacting the button component.

In one embodiment of the button input structure, the at least one substrate includes at least a first substrate and a second substrate separate from the first substrate, each of which is adhered to the top surface of the base plate. At least one of the mechanical switches is attached to a top surface of the first substrate, and at least another one of the mechanical switches is attached to a top surface of the second substrate. The button component sits on the mechanical switches. At least one of the strain-based sensors is attached to the top surface of the first substrate without contacting the button component, and at least another one of the strain-based sensors is attached to the top surface of the second substrate without contacting the button component.

In one embodiment of the button input structure, the at least one substrate includes a number of substrates, each of which accommodates either one or more of the strain-based sensors or one or more of the mechanical switches.

In one embodiment of the button input structure, the substrates include a first substrate, a second substrate, a third substrate, and a fourth substrate, which are separate from each other and adhered to the top surface of the base plate. At least one of the strain-based sensors is attached to a bottom surface of the first substrate, and at least another one of the strain-based sensors is attached to a bottom surface of the second substrate. The base plate includes individual holes to accommodate the strain-based sensors, respectively. At least one of the mechanical switches is attached to a top surface of the third substrate, and at least another one of the mechanical switches is attached to a top surface of the fourth substrate. The button component sits on the mechanical switches.

In one embodiment of the button input structure, the substrates include a first substrate, a second substrate, a third substrate, and a fourth substrate, which are separate from each other and adhered to a top surface of the base plate. At least one of the strain-based sensors is attached to a top surface of the first substrate without contacting the button component, and at least another one of the strain-based sensors is attached to a top surface of the second substrate without contacting the button component. At least one of the mechanical switches is attached to a top surface of the third substrate, and at least another one of the mechanical switches is attached to a top surface of the fourth substrate. The button component sits on the mechanical switches.

In one embodiment of the button input structure, the holding basket is a second part of the housing and includes a bottom portion and an arm portion that extends from the bottom portion and is connected to the first part of the housing. The air chamber is above the bottom portion and surrounded by the arm portion.

In one embodiment of the button input structure, the at least one substrate is adhered to a bottom surface of the button component. The mechanical switches are attached to a bottom surface of the at least one substrate, and sit on the bottom portion of the holding basket. The button component includes cavities, each of which extends from the bottom surface of the button component into the button component. Each of the strain-based sensors is attached to a top surface of the at least one substrate and located within a corresponding one of the cavities of the button component without contacting the button component.

In one embodiment of the button input structure, the at least one substrate includes at least a first substrate and a second substrate separate from the first substrate, each of which is adhered to a bottom surface of the button component. The button component includes cavities, each of which extends from the bottom surface of the button component into the button component. At least one of the strain-based sensors is attached to a top surface of the first substrate and located within a corresponding one of the cavities of the button component without contacting the button component, and at least another one of the strain-based sensors is attached to a top surface of the second substrate and located within another corresponding one of the cavities of the button component without contacting the button component. At least one of the mechanical switches is attached to a bottom surface of the first substrate, and at least another one of the mechanical switches is attached to a bottom surface of the second substrate. Each of the mechanical switches sits on the bottom portion of the holding basket.

In one embodiment of the button input structure, the button component has a hat configuration including a button body and a button rim. Herein, the button body has a slightly smaller horizontal size than the opening to ensure that the button component is capable of moving vertically through the opening. The button rim protrudes horizontally from a bottom portion of the button body, has a larger horizontal size than the opening, and is located underneath the opening, so as to secure the button component in place.

In one embodiment of the button input structure, a quantity of the mechanical switches and a quantity of the strain-based sensors are different.

In one embodiment of the button input structure, a quantity of the mechanical switches and a quantity of the strain-based sensors are the same.

In one embodiment of the button input structure, the mechanical switches and the strain-based sensors are located on a same surface of the at least one substrate.

In one embodiment of the button input structure, the mechanical switches and the strain-based sensors are located on opposite surfaces of the at least one substrate.

According to one embodiment, a method of operations of an electronic device with a button input structure, which includes a button component, a substrate, mechanical switches, and strain-based sensors, starts with at least partially actuating the mechanical switches by depression of the button component. Herein, the depression of the button component is caused by an external force applied to the button component. Next, strain on the substrate, which is mechanically connected to the button component, is sensed by the strain-based sensors. The strain is caused by the depression of the button component from the external force applied to the button component. An output is then provided by each of the strain-based sensors based on the sensed strain. The output indicates information of an amount of the external force applied to the button component and a touch location of the external force applied to the button component. The touch location of the external force applied to the button component is determined based on the output of each of the strain-based sensors. In addition, the amount of the external force applied to the button component is calculated based on the output of each of the strain-based sensors and the determined touch location of the external force.

In another aspect, any of the foregoing aspects individually or together, and/or various separate aspects and features as described herein, may be combined for additional advantage. Any of the various features and elements as disclosed herein may be combined with one or more other disclosed features and elements unless indicated to the contrary herein.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIGS. 1A-1D illustrate an exemplary implementation of a button input structure of an electronic device according to some embodiments.

FIGS. 2-8 illustrate alternative implementations of the button input structure of an electronic device according to some embodiments.

FIG. 9 illustrates a flowchart of operations of an exemplary electronic device that includes the button input structure shown in FIGS. 1A-8.

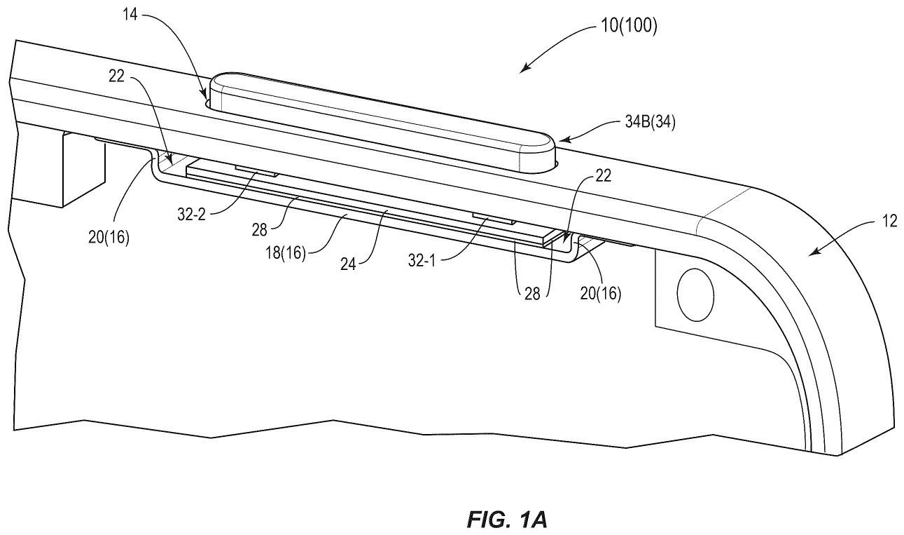

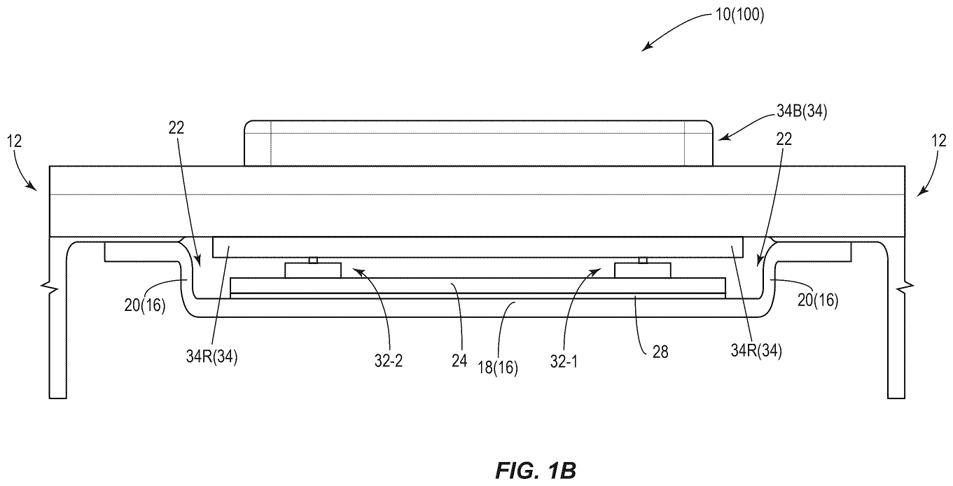

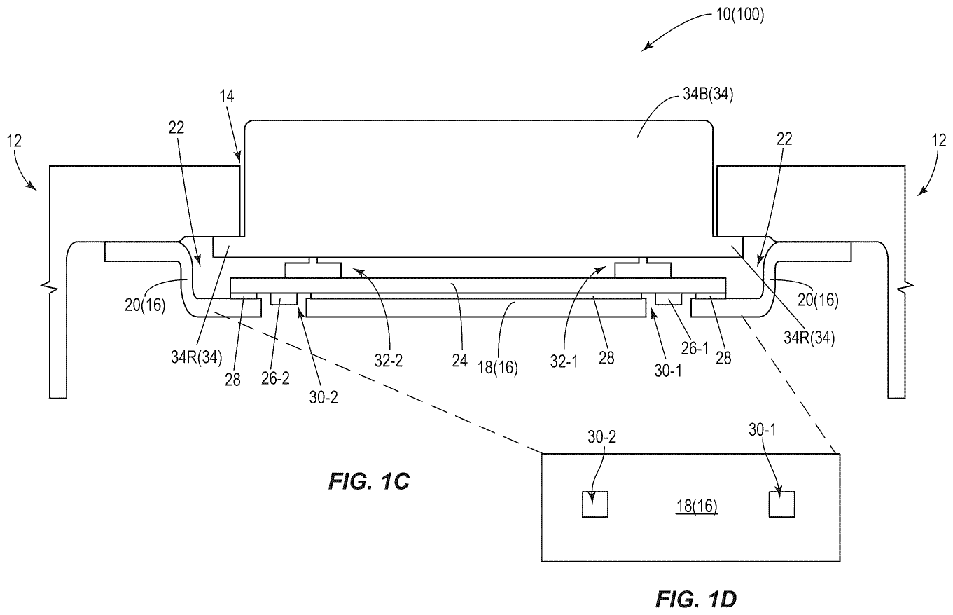

It will be understood that for clear illustrations, FIGS. 1A-9 may not be drawn to scale.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments are described herein with reference to schematic illustrations of embodiments of the disclosure. As such, the actual dimensions of the layers and elements can be different, and variations from the shapes of the illustrations as a result, for example, of manufacturing techniques and/or tolerances, are expected. For example, a region illustrated or described as square or rectangular can have rounded or curved features, and regions shown as straight lines may have some irregularity. Thus, the regions illustrated in the figures are schematic and their shapes are not intended to illustrate the precise shape of a region of a device and are not intended to limit the scope of the disclosure. Additionally, sizes of structures or regions may be exaggerated relative to other structures or regions for illustrative purposes and, thus, are provided to illustrate the general structures of the present subject matter and may or may not be drawn to scale. Common elements between figures may be shown herein with common element numbers and may not be subsequently re-described.

The present disclosure relates to a button input structure of an electronic device, which includes two or more mechanical switches to achieve a binary function and two or more strain-based sensors to detect an external force applied to the button input structure. Based on the detected information of the external force, the electronic device is capable of operating a sliding/scrolling/swiping function in addition to the binary function relying on the mechanical switches.

FIGS. 1A-1C illustrate an exemplary implementation of a button input structure 10 of an electronic device 100 according to some embodiments. The electronic device 100 includes a housing 12 with an opening 14, which accommodates the button input structure 10. In some embodiments, a portion of the housing 12 can be considered as a part of the button input structure 10. FIG. 1A illustrates an isometric view of the button input structure 10 and the housing 12, FIG. 1B illustrates a side view of the button input structure 10 and the housing 12, and FIG. 1C illustrates a cross-sectional view of the button input structure 10 and the housing 12.

In detail, the button input structure 10 includes a holding basket 16 confined within the housing 12, underneath the opening 14, and adhered to an internal side of the housing 12. Herein, the holding basket 16 is configured to provide mechanical support to other components of the button input structure 10 (more details are described below). The holding basket 16 may be formed of a spring-like material (e.g., stainless steel, alloy steel, or the like), which generates strains/strain changes due to external forces. The holding basket 16 includes a base plate 18 and a basket arm 20 that extends from the base plate 18 and is adhered to the internal side of the housing 12, so as to hold the base plate 18. The connection of the holding basket 16 to the internal side of the housing 12 provides an air chamber 22 that is above the base plate 18, surrounded by the basket arm 20, and connected to the opening 14 of the housing 12.

The button input structure 10 also includes a substrate 24 located within the air chamber 22 and two or more strain-based sensors 26 formed at a bottom surface of the substrate 24. The substrate 24 may be formed of a spring-like material (e.g., stainless steel, alloy steel, or the like), and the bottom surface of the substrate 24 is attached to a top surface of the base plate 18 via an adhesive layer 28. Herein, to accommodate the two or more strain-based sensors 26 formed at the bottom surface of the substrate 24, the base plate 18 of the holding basket 16 includes two or more individual holes 30, within each of which a corresponding strain-based sensor 26 is confined. Notice that the two or more holes 30 do not split the base plate 18, and the base plate 18 remains continuous as illustrated in FIG. 1D. The adhesive layer 28 is confined within the substrate 24 and does not extend over each hole 30. As such, each strain-based sensor 26 hangs underneath the bottom surface of the substrate 24 without contacting the adhesive layer 28 or the base plate 18.

For the purpose of this illustration, there are two strain-based sensors 26 (e.g., a first strain-based sensor 26-1 and a second strain-based sensor 26-2) located at a periphery of the bottom surface of the substrate 24 and confined within two holes 30 (e.g., a first hole 30-1 and a second hole 30-2) of the base plate 18, respectively. In different applications, the button input structure 10 may include more strain-based sensors 26 placed at different locations on the bottom surface of the substrate 24, and the base plate 18 may include more holes 30, accordingly. In some applications, the base plate 18 may include two or more recesses, which do not vertically extend through the base plate 18, to accommodate the strain-based sensors 26 rather than the holes 30 (not shown).

In addition, the button input structure 10 includes two or more mechanical switches 32, which are located on a top surface of the substrate 24 and within the air chamber 22, and a button component 34, which extends through the opening 14 of the housing 12 and into the air chamber 22 without adhering to any portion of the housing 12 and sits on the mechanical switches 32. For the purpose of this illustration, there are two mechanical switches 32 (e.g., a first mechanical switch 32-1 and a second mechanical switch 32-2) located at a periphery of the top surface of the substrate 24. The button component 34 has a hat configuration with a button body 34B and a button rim 34R. The button body 34B has a slightly smaller horizontal size than the opening 14 of the housing 12 to ensure that the button component 34 can move vertically through the opening 14 smoothly. The button body 34B also extends vertically beyond an outer surface of the housing 12 to make the button component 34 accessible to users. The button rim 34R protrudes horizontally from a bottom portion of the button body 34B, has a larger horizontal size than the opening 14 of the housing 12, and is located underneath the housing 12, which secures the button component 34 in place. In different applications, the button input structure 10 may include more mechanical switches 32 placed at different locations on the top surface of the substrate 24, and the button component 34 may have a different shape/configuration. Herein, the mechanical switches 32 are configured to provide a binary function to the electronic device 100, such as ON/OFF or UP/DOWN. When an external force (e.g., finger pressure) is applied to the button body 34B of the button component 34 protruding outside of the housing 12, the button component 34 may be depressed and in consequence may thereby actuate the mechanical switches 32 beneath it, thus enabling a binary function.

Since the button component 34, the mechanical switches 32, the substrate 24, and the holding basket 16 (the base plate 18) are mechanically connected, the external force applied to the button component 34 may transfer to the substrate 24 through the mechanical switch 32 and further to the holding basket 16 through the adhesive layer 28, and cause strain/strain change on the substrate 24 as well as the base plate 18 of the holding basket 16. Herein and hereafter, if two components are mechanically connected, it indicates that a force applied to one of the two components can be transferred to the other component. When the external force is applied continuously, each strain-based sensor 26, which is attached to the bottom surface of the substrate 24, is configured to sense the strain/strain change on the substrate 24 and configured to provide an output indicating information of an amount of the external force applied to the button component 34. In addition, the holding basket 16 adhered to the internal side of the housing 12 is also configured to provide mechanical support to the substrate 24, the mechanical switches 32, and the button component 34.

For a non-limiting example, as the button component 34 partially actuates the mechanical switches 32, the strain/strain change is transferred onto the strain-based sensors 26 through the button component 34, the mechanical switches 32, and the substrate 24. After the button component 34 is depressed and actuates the mechanical switches 32, the strain is continued to be transferred to the strain-based sensors 26 as long as the external force is continuously applied to the button component 34. In some applications, the strain may be non-linear from before the actuation of the mechanical switches 32 to after the actuation of the mechanical switches 32. In some applications, the strain is linear throughout the actuation of the mechanical switches 32.

On the other hand, since the strain-based sensors 26 are disposed at different locations, the strain/strain change on the substrate 24 sensed by different strain-based sensors 26 may be different. For a non-limiting example, when an external force is applied vertically above the first strain-based sensor 26-1 and horizontally away from the second strain-based sensor 26-2, the first strain-based sensor 26-1 may sense a greater strain/strain change than the second strain-based sensor 26-2 and may provide a larger output than the second strain-based sensor 26-2. In other words, the first strain-based sensor 26-1 contributes more to a total output of the strain-based sensors 26 than the second strain-based sensor 26-2. In general, each strain-based sensor 26 contribution to the total output of all strain-based sensors 26 will vary with the touch location on the button component 34 of the external force applied, thereby providing a unique contribution profile for each touch location. Utilizing a mapping (e.g., predetermined) between these contribution profiles and different touch locations, the touch location of the external force applied can be estimated (e.g., by a microprocessor electrically connected to the button input structure 10 and within the electronic device 100, not shown) without the use of any other sensing technology.

Note that the amount of the external force applied to the button component 34 may not be directly provided by the strain-based sensors 26 but may be calculated by normalizing the outputs of the strain-based sensors 26 based on a calibration table, which contains sensing sensitivity as a function of the touch location for each strain-based sensor 26. As such, once the outputs of the strain-based sensors 26 and the touch location of the external force are determined, the amount of the external force applied to the button component 34 can be estimated (e.g., by a microprocessor electrically connected to the button input structure 10 and within the electronic device 100, not shown). Herein, based on the strain detection/output of each strain-based sensor 26, both the amount of the external force and the touch location of the external force can be estimated. In consequence, based on the estimated amount and touch location of the external force applied, the electronic device 100 is capable of performing another function, such as a sliding/scrolling function or a swiping function, in addition to the binary function relying on the mechanical switches 32. Algorithms used for the calculation of the amount of the external force and the determination of the touch locations of the external force, and the determined touch locations of the external force and the calculated amount of the external force applied to the button component 34 may be stored in a memory component (not shown) of the electronic device 100 (the memory component is electrically connected to the microprocessor of the electronic device 100).

Typically, as long as the strain-based sensors 26 continue to sense the strains caused by the external force (e.g., on the substrate 24/the base plate 18 of the holding basket 16), the amount of the external force and the touch location of the external force can be continuously estimated, and accordingly, the electronic device 100 can achieve the sliding/scrolling/swiping function. Depending on implementations, before or after the button component 34 is completely depressed and actuates the mechanical switches 32, the sliding/scrolling/swiping function can be achieved as long as the external force is continuously applied on the button component 34.

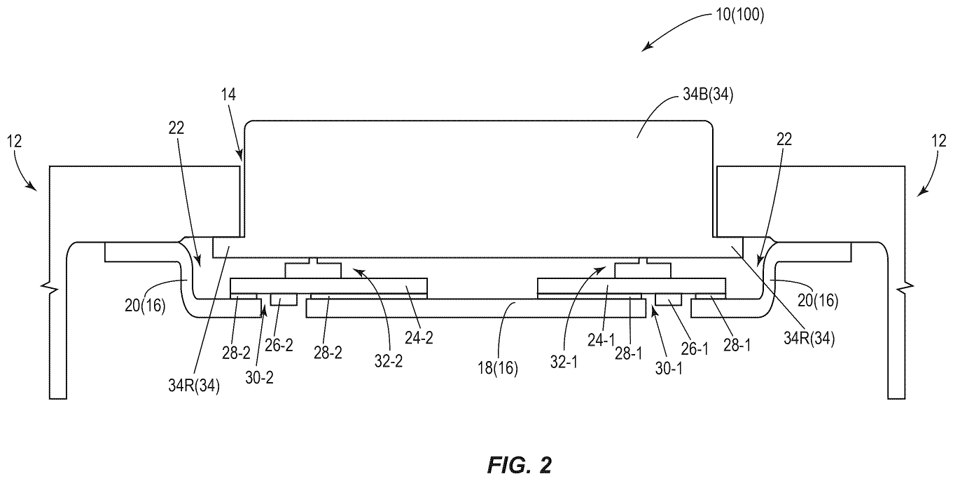

In some applications, the button input structure 10 may include more than one substrate 24 to accommodate the strain-based sensors 26 and the mechanical switches 32, as illustrated in FIG. 2. For the purpose of this illustration, the button input structure 10 includes two substrates 24: a first substrate 24-1 and a second substrate 24-2. Herein, both the first substrate 24-1 and the second substrate 24-2 are attached to the top surface of the base plate 18 via corresponding adhesive layers 28 (e.g., a first adhesive layer 28-1 and a second adhesive layer 28-2), respectively, and are located within the air chamber 22. The first strain-based sensor 26-1 is attached to a bottom surface of the first substrate 24-1 and still hangs in the first hole 30-1 of the base plate 18, while the first mechanical switch 32-1 is located on a top surface of the first substrate 24-1 and within the air chamber 22. Similarly, the second strain-based sensor 26-2 is attached to a bottom surface of the second substrate 24-2 and still hangs in the second hole 30-2 of the base plate 18, while the second mechanical switch 32-2 is located on a top surface of the second substrate 24-2 and within the air chamber 22. The button component 34 still extends through the opening 14 of the housing 12 and into the air chamber 22 without adhering to any portion of the housing 12 and sits on the first and second mechanical switches 32. In different applications, the button input structure 10 may include more substrates 24 and more corresponding adhesive layers 28, and more strain-based sensors 26 and/or mechanical switches 32 attached to each substrate 24. The number of the strain-based sensors 26 and the number of the mechanical switches 32 attached to each substrate 24 can be arbitrary, depending on different applications. The number of the strain-based sensors 26/the mechanical switches 32 attached to each substrate 24 may be the same or different.

In this embodiment, the button component 34, the mechanical switches 32, the substrates 24, and the holding basket 16 (the base plate 18) are still mechanically connected. When an external force (e.g., finger pressure) is applied to the button component 34, the button component 34 can be depressed to actuate the mechanical switches 32 beneath it, which are configured to provide a binary function to the electronic device 100 (as described above). In addition, when the external force is continuously applied to the button component 34, each strain-based sensor 26 is still configured to sense the strain/strain change on the substrate 24, which is caused by the external force applied to the button component 34 and transferred through the mechanical switch 32, and configured to provide an output indicating information of the external force (e.g., an amount of the external force and a touch location of the external force, as described above). Based on the strain detection/output of each strain-based sensor 26, both the amount of the external force and the touch location of the external force can be estimated. In consequence, based on the estimated amount and touch location of the external force applied, the electronic device 100 is capable of performing another function, such as a sliding/scrolling function or a swiping function, in addition to the binary function relying on the mechanical switches 32.

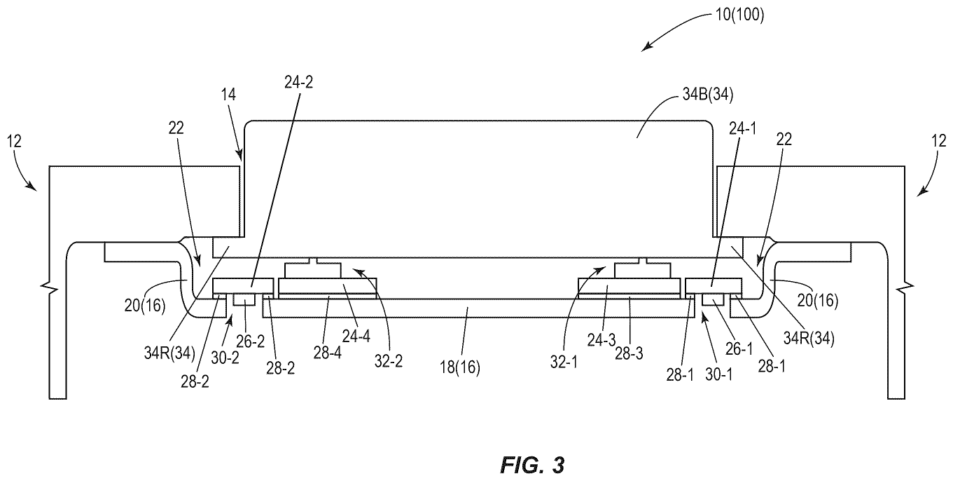

As shown in FIGS. 1C and 2, certain strain-based sensor(s) 26 and certain mechanical switch(es) 32 share one substrate 24. In some applications, the strain-based sensors 26 and the mechanical switches 32 are attached to different substrates 24, as illustrated in FIG. 3. For the purpose of this illustration, the button input structure 10 includes four substrates 24: a first substrate 24-1, a second substrate 24-2, a third substrate 24-3, and a fourth substrate 24-4. Herein, the first substrate 24-1, the second substrate 24-2, the third substrate 24-3, and the fourth substrate 24-4 are attached to the top surface of the base plate 18 via corresponding adhesive layers 28 (e.g., a first adhesive layer 28-1, a second adhesive layer 28-2, a third adhesive layer 28-3, and a fourth adhesive layer 28-4), respectively, and are located within the air chamber 22. The third substrate 24-3 and the fourth substrate 24-4 are located horizontally between the first substrate 24-1 and the second substrate 24-2.

The first strain-based sensor 26-1 is attached to a bottom surface of the first substrate 24-1 and hangs in the first hole 30-1 of the base plate 18, and the second strain-based sensor 26-2 is attached to a bottom surface of the second substrate 24-2 and hangs in the second hole 30-2 of the base plate 18. The first mechanical switch 32-1 is located on a top surface of the third substrate 24-3, and the second mechanical switch 32-2 is located on a top surface of the fourth substrate 24-4. The button component 34 still extends through the opening 14 of the housing 12 and into the air chamber 22 without adhering to any portion of the housing 12 and sits on the first and second mechanical switches 32. In different applications, the button input structure 10 may include fewer or more substrates 24, and each substrate 24 may accommodate more than one strain-based sensor 26 or more than one mechanical switch 32. A horizontal layout of the strain-based sensors 26 and the mechanical switches 32 may be different (e.g., the strain-based sensors 26 are located horizontally between the mechanical switches 32, or the strain-based sensors 26 alternate horizontally with the mechanical switches 32, or etc.).

In this embodiment, the button component 34, the mechanical switches 32, the substrates 24, and the holding basket 16 (the base plate 18) are still mechanically connected. When an external force (e.g., finger pressure) is applied to the button component 34, the button component 34 can be depressed to actuate the mechanical switches 32 beneath it, which are configured to provide a binary function to the electronic device 100 (as described above). In addition, the external force continuously applied to the button component 34 will cause continuous strain/strain change on the first substrate 24-1 and the second substrate 24-2 through the mechanical switches 32, the third and fourth substrates 24-3 and 24-4, and the base plate 18. Each strain-based sensor 26 continuously senses the strain/strain change on the corresponding substrate 24 and is configured to provide an output indicating information of the external force (e.g., an amount of the external force and a touch location of the external force, as described above). Based on the strain detection/output of each strain-based sensor 26, both the amount of the external force and the touch location of the external force can be estimated. In consequence, based on the estimated amount and touch location of the external force applied, the electronic device 100 is capable of performing another function, such as a sliding/scrolling function or a swiping function, in addition to the binary function relying on the mechanical switches 32.

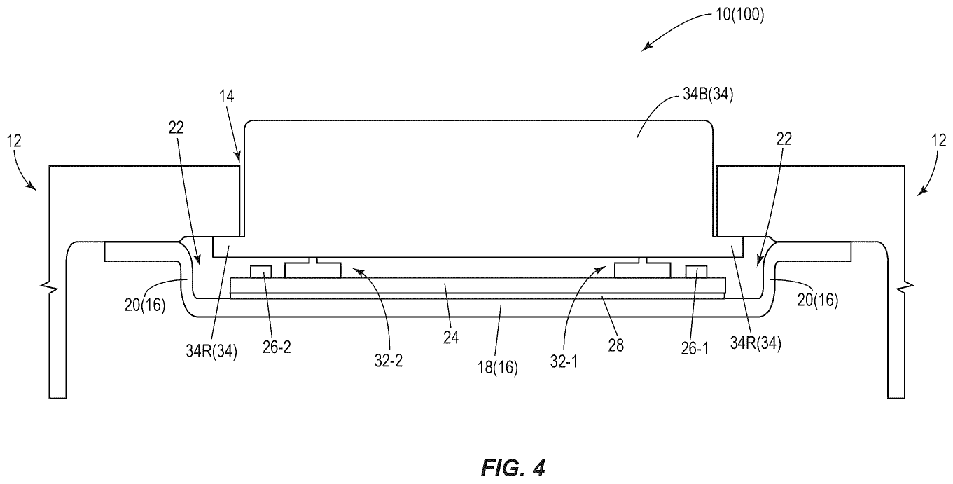

As described above, the strain-based sensors 26 and the mechanical switches 32 are attached to opposite surfaces of the substrate(s) 24. In some applications, the strain-based sensors 26 and the mechanical switches 32 may be located on a same surface of the substrate 24, as illustrated in FIG. 4. For the purpose of this illustration, the substrate 24 is attached to the top surface of the base plate 18 of the holding basket 16 via one adhesive layer 28 and is located within the air chamber 22. The first and second strain-based sensors 26-1 and 26-2 are attached to a periphery of the top surface of the substrate 24, while the first and second mechanical switches 32-1 and 32-2 are attached to the same top surface of the substrate 24 and located horizontally between the first and second strain-based sensors 26-1 and 26-2. Since the base plate 18 does not need to accommodate the strain-based sensors 26, the holes 30 can be omitted in the base plate 18, while the adhesive layer 28 covers the bottom surface of the substrate 24 without gaps. The button component 34 still extends through the opening 14 of the housing 12 and into the air chamber 22 without adhering to any portion of the housing 12, and sits on the mechanical switches 32. Herein, each strain-based sensor 26 is shorter than the mechanical switches 32, such that the button component 34 does not touch any of the strain-based sensors 26. In different applications, the button input structure 10 may include more strain-based sensors 26 and/or mechanical switches 32 attached to the top surface of the substrate 24 with a different horizontal layout.

In this embodiment, when an external force (e.g., finger pressure) is applied to the button component 34, the button component 34 can be depressed to actuate the mechanical switches 32 beneath it, which are configured to provide a binary function to the electronic device 100 (as described above). In addition, the external force continuously applied to the button component 34 will cause a continuous strain/strain change on the substrate 24 through the mechanical switches 32. Since each strain-based sensor 26 is shorter than the mechanical switches 32 and is not in contact with the button component 34, the external force transferring to the substrate 24 and further to the base plate 18 does not go through the strain-based sensors 26. Each strain-based sensor 26 continuously senses the strain/strain change on the substrate 24 and is configured to provide an output indicating information of the external force (e.g., an amount of the external force and a touch location of the external force, as described above). Based on the strain detection/output of each strain-based sensor 26, both the amount of the external force and the touch location of the external force can be estimated. In consequence, based on the estimated amount and touch location of the external force applied, the electronic device 100 is capable of performing another function, such as a sliding/scrolling function or a swiping function, in addition to the binary function relying on the mechanical switches 32.

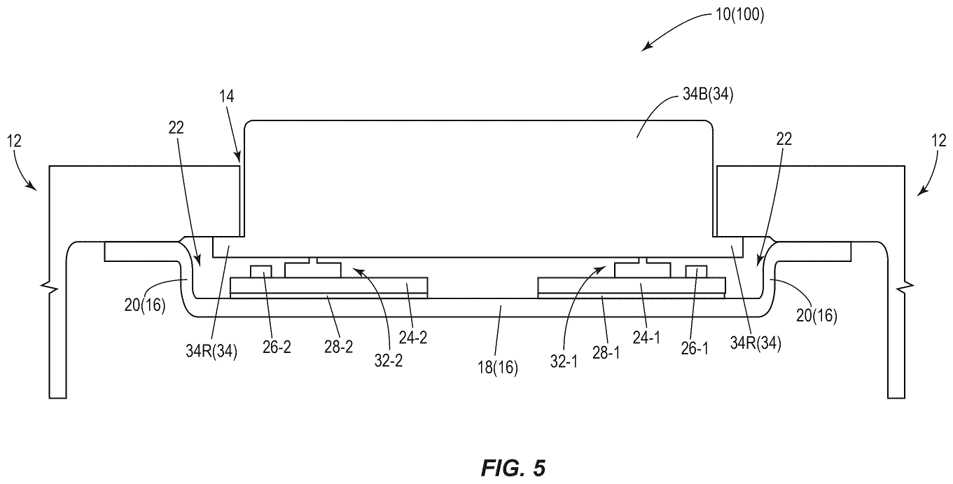

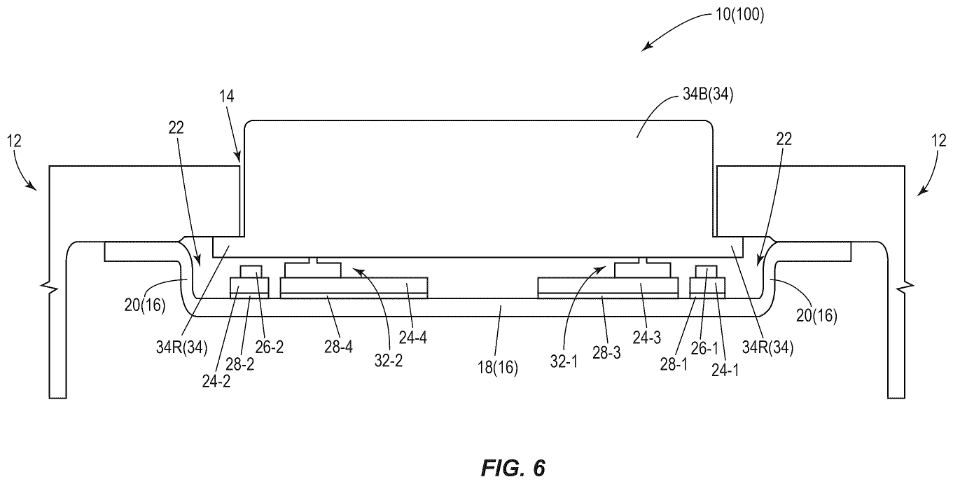

In some applications, the strain-based sensors 26 and/or the mechanical switches 32 may be located on top surfaces of different substrates 24, as illustrated in FIGS. 5 and 6. In FIG. 5, the button input structure 10 includes the first substrate 24-1 and the second substrate 24-2, each of which is attached to the top surface of the base plate 18 via a corresponding adhesive layer 28 (e.g., the first adhesive layer 28-1 and the second adhesive layer 28-2), respectively, and are located within the air chamber 22. The first strain-based sensor 26-1 and the first mechanical switch 32-1 are attached to the top surface of the first substrate 24-1, while the second strain-based sensor 26-2 and the second mechanical switch 32-2 are attached to the top surface of the second substrate 24-2, where the first and second mechanical switches 32-1 and 32-2 are located horizontally between the first and second strain-based sensors 26-1 and 26-2. In FIG. 6, the button input structure 10 includes the four substrates (e.g., the first substrate 24-1, the second substrate 24-2, the third substrate 24-3, and the fourth substrate 24-4), each of which is attached to the top surface of the base plate 18 via a corresponding adhesive layer 28 (e.g., the first adhesive layer 28-1, the second adhesive layer 28-2, the third adhesive layer 28-3, and the fourth adhesive layer 28-4), respectively, and are located within the air chamber 22. The first strain-based sensor 26-1 is attached to the top surface of the first substrate 24-1, the second strain-based sensor 26-2 is attached to the top surface of the second substrate 24-2, the first mechanical switch 32-1 is attached to a top surface of the third substrate 24-3, and the second mechanical switch 32-2 is attached to a top surface of the fourth substrate 24-4, where the first and second mechanical switches 32-1 and 32-2 are located horizontally between the first and second strain-based sensors 26-1 and 26-2.

In both scenarios, the button component 34 still extends through the opening 14 of the housing 12 and into the air chamber 22 without adhering to any portion of the housing 12 and sits on the mechanical switches 32. Herein, each strain-based sensor 26 is shorter than the mechanical switches 32, such that the button component 34 does not touch any of the strain-based sensors 26. In different applications, the button input structure 10 may include fewer or more substrates 24, more strain-based sensors 26 and/or mechanical switches 32 may be attached to the top surfaces of different substrates 24, and the horizontal layout of the strain-based sensors 26 and the mechanical switches 32 may be different.

In FIGS. 5-6, when an external force (e.g., finger pressure) is applied to the button component 34, the button component 34 can be depressed to actuate the mechanical switches 32 beneath it, which are configured to provide a binary function to the electronic device (as described above). In addition, the external force continuously applied to the button component 34 will cause a continuous strain/strain change on the first and second substrates 24-1 and 24-2. In FIG. 5, the external force continuously applied to the button component 34 is transferred to the first and second substrates 24-1 and 24-2 through the mechanical switches 32. In FIG. 6, the external force continuously applied to the button component 34 is transferred to the first and second substrates 24-1 and 24-2 through the mechanical switches 32, the third and fourth substrates 24-3 and 24-4, and the base plate 18. Since each strain-based sensor 26 is shorter than the mechanical switches 32 and is not in contact with the button component 34, the external force transferring to the base plate 18 does not go through the strain-based sensors 26. Each strain-based sensor 26 continuously senses the strain/strain change on the corresponding substrate 24 and is configured to provide an output indicating information of the external force (e.g., an amount of the external force and a touch location of the external force, as described above). Based on the strain detection/output of each strain-based sensor 26, both the amount of the external force and the touch location of the external force can be estimated. In consequence, based on the estimated amount and touch location of the external force applied, the electronic device 100 is capable of performing another function, such as a sliding/scrolling function or a swiping function, in addition to the binary function relying on the mechanical switches 32.

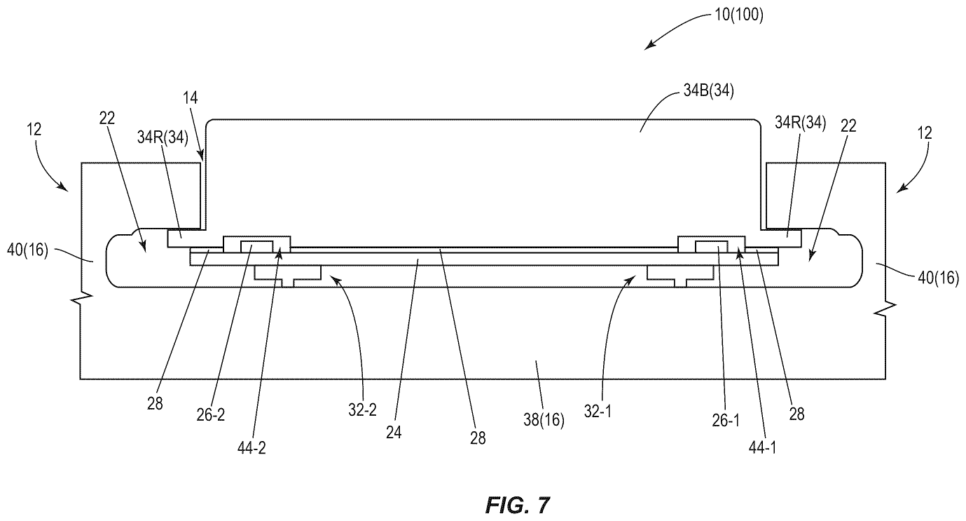

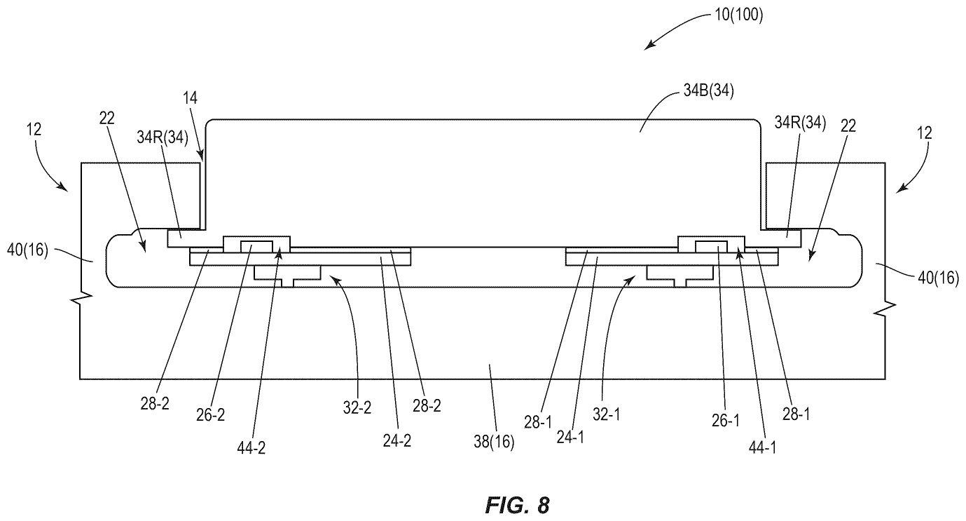

In some applications, the holding basket 16 may be implemented by portions of the housing 12, as illustrated in FIGS. 7 and 8. Herein, the holding basket 16 includes a bottom portion 38 and an arm portion 40 to provide mechanical support to the mechanical switches 32, the substrate(s) 24, the strain-based sensors 26, and the button component 34. The arm portion 40 extends from the bottom portion 38 and is connected to an internal portion of the housing 12. In some embodiments, the bottom portion 38 and the arm portion 40 may be integrated with the internal portion of the housing 12 as a single piece. The holding basket 16 with the bottom portion 38 and the arm portion 40 still provides the air chamber 22 that is above the bottom portion 38, surrounded by the arm portion 40, and connected to the opening 14. The bottom portion 38 and the arm portion 40 may be formed of a spring-like material (e.g., stainless steel, alloy steel, or the like) and may be considered as a part of the button input structure 10.

For the purpose of these two illustrations, the button component 34 still extends through the opening 14 of the housing 12 and into the air chamber 22 without adhering to any portion of the housing 12. Herein, instead of sitting directly on the mechanical switches 32, the button component 34 is connected to the substrate(s) 24 via the adhesive layer 28. In addition, the button component 34 includes two cavities 44 (e.g., a first cavity 44-1 and a second cavity 44-2) extending from a bottom surface of the button component 34 into the button component 34 to accommodate the strain-based sensors 26.

In FIG. 7, the button input structure 10 includes one substrate 24 attached to the bottom surface of the button component 34 via the adhesive layer 28 to accommodate the strain-based sensors 26 and the mechanical switches 32. Each strain-based sensor 26 is attached to the top surface of the substrate 24 and is located within a corresponding cavity 44 of the button component 34. Herein, each strain-based sensor 26 is shorter than a depth of a corresponding cavity 44 and is not in contact with the button component 34. Each mechanical switch 32 is located vertically between the bottom surface of the substrate 24 and a top surface of the bottom portion 38 of the housing 12, and within the air chamber 22. Each mechanical switch 32 is attached to the bottom surface of the substrate 24 and extends to contact or be adjacent to the top surface of the bottom portion 38. In different applications, there might be more strain-based sensors 26 attached to the top surface of the substrate 24, and accordingly, the button component 34 may have more cavities 44 to accommodate these more strain-based sensors 26. In addition, there might be more mechanical switches 32 located vertically between the bottom surface of the substrate 24 and a top surface of the bottom portion 38 of the housing 12.

When an external force (e.g., finger pressure) is applied to the button component 34, the button component 34 can be depressed to actuate the mechanical switches 32 via the substrate 24, so as to provide a binary function to the electronic device (as described above). In addition, the external force continuously applied to the button component 34 will cause a continuous strain/strain change on the substrate 24 (through the adhesive layer 28). Since each strain-based sensor 26 is shorter than the depth of the corresponding cavity 44 and is not in contact with the button component 34, the external force transferring to the bottom portion 38 of the housing 12 does not go through the strain-based sensors 26. Each strain-based sensor 26 continuously senses the strain/strain change on the substrate 24 and is configured to provide an output indicating information of the external force (e.g., an amount of the external force and a touch location of the external force, as described above). Based on the strain detection/output of each strain-based sensor 26, both the amount of the external force and the touch location of the external force can be estimated. In consequence, based on the estimated amount and touch location of the external force applied, the electronic device 100 is capable of performing another function, such as a sliding/scrolling function or a swiping function, in addition to the binary function relying on the mechanical switches 32.

In FIG. 8, the button input structure 10 includes two substrates 24: the first substrate 24-1 and the second substrate 24-2, each of which is attached to the bottom surface of the button component 34 via a corresponding adhesive layer 28 to accommodate one or more strain-based sensors 26 and one or more mechanical switches 32. Herein, the first strain-based sensor 26-1 is attached to the top surface of the first substrate 24-1, and is located within the first cavity 44-1 of the button component 34, and the second strain-based sensor 26-2 is attached to the top surface of the second substrate 24-2, and located within the second cavity 44-2 of the button component 34. Each strain-based sensor 26 is shorter than the depth of a corresponding cavity 44 and is not in contact with the button component 34. The first mechanical switch 32-1 is located vertically between the bottom surface of the first substrate 24-1 and the top surface of the bottom portion 38 of the housing 12, and the second mechanical switch 32-2 is located vertically between the bottom surface of the second substrate 24-2 and the top surface of the bottom portion 38 of the housing 12. Each mechanical switch 32 is attached to the bottom surface of the corresponding substrate 24 and extends to contact or be adjacent to the top surface of the bottom portion 38. In different applications, the button input structure 10 may include more substrates 24 attached to the bottom surface of the button component 34 via corresponding adhesive layers 28, respectively. Each substrate 24 may accommodate more mechanical switches 32 on its bottom surface (i.e., more mechanical switches 32 located vertically between the bottom surface of one substrate 24 and the top surface of the bottom portion 38 of the housing 12) and/or more strain-based sensors 26 on its top surface. And accordingly, the button component 34 may have more cavities 44 to accommodate these more strain-based sensors 26. The number of the strain-based sensors 26 and the number of the mechanical switches 32 attached to each substrate 24 can be arbitrary, depending on different applications. The number of the strain-based sensors 26/the mechanical switches 32 attached to each substrate 24 may be the same or different.

When an external force (e.g., finger pressure) is applied to the button component 34, the button component 34 can be depressed to actuate each mechanical switch 32 via the corresponding adhesive layer 28 and the corresponding substrate 24, so as to provide a binary function to the electronic device 100 (as described above). In addition, the external force continuously applied to the button component 34 will cause the continuous strain/strain change on the first and second substrates 24-1 and 24-2. Since each strain-based sensor 26 is shorter than the depth of the corresponding cavity 44 and is not in contact with the button component 34, the external force transferring to the bottom portion 38 of the housing 12 does not go through the strain-based sensors 26. Each strain-based sensor 26 continuously senses the strain/strain change on the corresponding substrate 24 and is configured to provide an output indicating information of the external force (e.g., an amount of the external force and a touch location of the external force, as described above). Based on the strain detection/output of each strain-based sensor 26, both the amount of the external force and the touch location of the external force can be estimated. In consequence, based on the estimated amount and touch location of the external force applied, the electronic device 100 is capable of performing another function, such as a sliding/scrolling function or a swiping function, in addition to the binary function relying on the mechanical switches 32.

FIGS. 1A-8 illustrate exemplary implementations of the button input structure 10 within an electronic device 100. Other implementations of the button input structure 10 may also be possible. The quantity of the strain-based sensors 26 and the mechanical switches 32 can be of any number from two to as many as desired. In addition, the strain-based sensors 26 and the mechanical switches 32 can be placed at various locations within the button input structure 10, as long as the strain-based sensors 26 are capable of continuously sensing strains caused by the external force applied to the button component 34, and as long as the mechanical switches 32 can be actuated by the depression of the button component 34 caused by the external force applied to the button component 34.

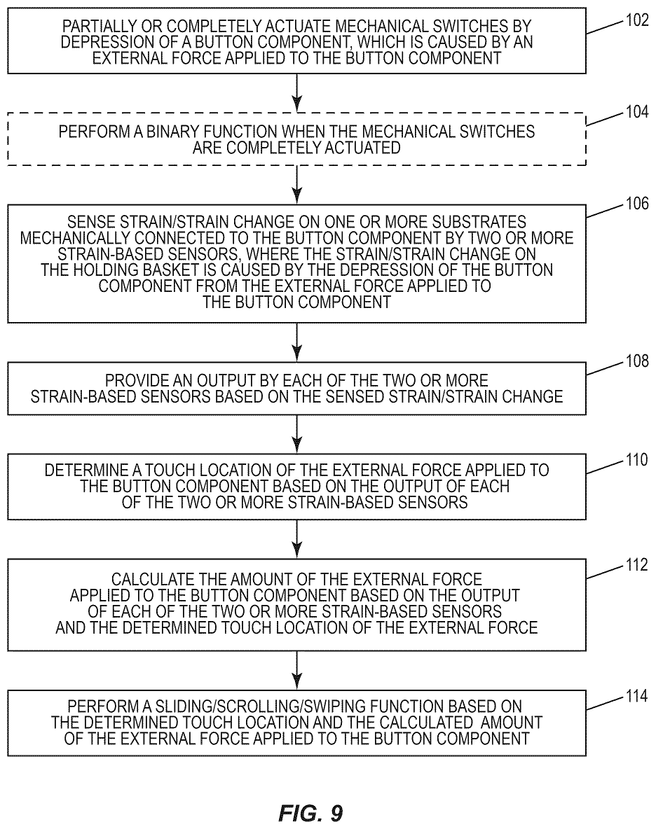

FIG. 9 illustrates a flowchart of operations of an electronic device (e.g., the electronic device 100) with a button input structure (e.g., the button input structure 10 shown in FIGS. 1A-8) according to some embodiments of the present disclosure. Although the process steps are illustrated in a series, the process steps are not necessarily order dependent. Some steps may be done in a different order than that presented. Further, processes within the scope of this disclosure may include fewer or more steps than those illustrated in FIG. 9.

Initially, when an external force is applied to a button component of the button input structure (e.g., the button component 34 of the button input structure 10), mechanical switches underneath the button component (e.g., the mechanical switches 32) are partially or completely actuated by depression of the button component (step 102). Optionally, if the mechanical switches are completely actuated, a binary function, such as ON/OFF or UP/DOWN, is performed by the electronic device (step 104).

As long as the external force is continuously applied to the button component of the button input structure, two or more strain-based sensors of the button input structure (e.g., the strain-based sensors 26) continuously sense strain/strain change on one or more substrates (e.g., the substrate(s) 24), which are mechanically connected to the button component (step 106). Herein, the strain/strain change on the one or more substrates is caused by the depression of the button component from the external force applied to the button component. Based on the sensed strain/strain change on the one or more substrates, each of the two or more strain-based sensors is configured to provide an output that indicates information of an amount of the external force applied to the button component as well as a touch location of the external force applied to the button component (step 108).

Next, based on the output of each of the two or more strain-based sensors, the touch location of the external force applied to the button component is determined by a microprocessor of the electronic device (step 110). The amount of the external force applied to the button component is then calculated by the microprocessor of the electronic device based on the output of each of the two or more strain-based sensors and the determined touch location of the external force (step 112). Lastly, the electronic device performs a sliding/scrolling/swiping function based on the determined touch location and the calculated amount of the external force applied to the button component (114).

It is contemplated that any of the foregoing aspects, and/or various separate aspects and features as described herein, may be combined for additional advantage. Any of the various embodiments as disclosed herein may be combined with one or more other disclosed embodiments unless indicated to the contrary herein.

Those skilled in the art will recognize improvements and modifications to the preferred embodiments of the present disclosure. All such improvements and modifications are considered within the scope of the concepts disclosed herein and the claims that follow.

What is claimed is:

1. A button input structure of an electronic device comprising:
a button component;
mechanical switches;
strain-based sensors;
at least one substrate underneath the button component to accommodate the mechanical switches and the strain-based sensors; and
a holding basket, which is configured to provide mechanical support to the at least one substrate, the strain-based sensors, the mechanical switches, and the button component, wherein:
the button component, the mechanical switches, the at least one substrate, and the holding basket are mechanically connected, such that depression of the button component caused by an external force applied to the button component is capable of producing strain on the at least one substrate; and
each of the strain-based sensors is attached to the at least one substrate and configured to detect the external force applied to the button component by sensing the strain on the at least one substrate and configured to provide an output indicating information of a touch point of the external force and an amount of the external force.

2. The button input structure of claim 1 wherein:
the at least one substrate is formed of a first spring-like material; and
the holding basket is formed of a second spring-like material.

3. The button input structure of claim 2 wherein:
the first spring-like material is stainless steel or alloy steel; and
the second spring-like material is stainless steel or alloy steel.

4. The button input structure of claim 1 further comprising a first part of a housing of the electronic device, wherein:
the first part of the housing includes an opening;
the holding basket is adhered to the first part of the housing and underneath the opening to provide an air chamber connected to the opening; and
the button component extends through the opening and into the air chamber without adhering to the first part of the housing.

5. The button input structure of claim 4 wherein:
the holding basket includes a base plate and a basket arm that extends from the base plate and is adhered to the first part of the housing, so as to hold the base plate; and
the air chamber is above the base plate and surrounded by the basket arm.

6. The button input structure of claim 5 wherein:
a bottom surface of the at least one substrate is adhered to a top surface of the base plate;
the mechanical switches are attached to a top surface of the at least one substrate, and the button component sits on the mechanical switches;
the strain-based sensors are attached to the bottom surface of the at least one substrate; and
the base plate includes individual holes to accommodate the strain-based sensors, respectively.

7. The button input structure of claim 5 wherein:
the at least one substrate includes at least a first substrate and a second substrate separate from the first substrate, wherein a bottom surface of first substrate and a bottom surface of the second substrate are adhered to a top surface of the base plate;
at least one of the strain-based sensors is attached to the bottom surface of the first substrate;
at least another one of the strain-based sensors is attached to the bottom surface of the second substrate;
the base plate includes individual holes to accommodate the strain-based sensors, respectively;
at least one of the mechanical switches is attached to a top surface of the first substrate, and at least another one of the mechanical switches is attached to a top surface of the second substrate; and
the button component sits on the mechanical switches.

8. The button input structure of claim 5 wherein:
the at least one substrate is adhered to a top surface of the base plate;
the mechanical switches are attached to a top surface of the at least one substrate, and the button component sits on the mechanical switches; and
the strain-based sensors are attached to the top surface of the at least one substrate without contacting the button component.

9. The button input structure of claim 5 wherein:
the at least one substrate includes at least a first substrate and a second substrate separate from the first substrate, each of which is adhered to a top surface of the base plate;
at least one of the mechanical switches is attached to a top surface of the first substrate, and at least another one of the mechanical switches is attached to a top surface of the second substrate;
the button component sits on the mechanical switches;
at least one of the strain-based sensors is attached to the top surface of the first substrate without contacting the button component; and
at least another one of the strain-based sensors is attached to the top surface of the second substrate without contacting the button component.

10. The button input structure of claim 5 wherein the at least one substrate includes a plurality of substrates, each of which accommodates either one or more of the strain-based sensors or one or more of the mechanical switches.

11. The button input structure of claim 10 wherein:
the plurality of substrates includes a first substrate, a second substrate, a third substrate, and a fourth substrate, which are separate from each other and adhered to a top surface of the base plate;
at least one of the strain-based sensors is attached to a bottom surface of the first substrate, and at least another one of the strain-based sensors is attached to a bottom surface of the second substrate;
the base plate includes individual holes to accommodate the strain-based sensors, respectively;
at least one of the mechanical switches is attached to a top surface of the third substrate, and at least another one of the mechanical switches is attached to a top surface of the fourth substrate; and
the button component sits on the mechanical switches.

12. The button input structure of claim 10 wherein:
the plurality of substrates includes a first substrate, a second substrate, a third substrate, and a fourth substrate, which are separate from each other and adhered to a top surface of the base plate;
at least one of the strain-based sensors is attached to a top surface of the first substrate without contacting the button component;
at least another one of the strain-based sensors is attached to a top surface of the second substrate without contacting the button component;
at least one of the mechanical switches is attached to a top surface of the third substrate, and at least another one of the mechanical switches is attached to a top surface of the fourth substrate; and
the button component sits on the mechanical switches.

13. The button input structure of claim 4 wherein:
the holding basket is a second part of the housing and includes a bottom portion and an arm portion that extends from the bottom portion and is connected to the first part of the housing; and
the air chamber is above the bottom portion and surrounded by the arm portion.

14. The button input structure of claim 13 wherein:
the at least one substrate is adhered to a bottom surface of the button component;
the mechanical switches are attached to a bottom surface of the at least one substrate, and sit on the bottom portion of the holding basket;
the button component includes cavities, each of which extends from the bottom surface of the button component into the button component; and
each of the strain-based sensors is attached to a top surface of the at least one substrate and located within a corresponding one of the cavities of the button component without contacting the button component.

15. The button input structure of claim 13 wherein:
the at least one substrate includes at least a first substrate and a second substrate separate from the first substrate, each of which is adhered to a bottom surface of the button component;
the button component includes cavities, each of which extends from the bottom surface of the button component into the button component;
at least one of the strain-based sensors is attached to a top surface of the first substrate and located within a corresponding one of the cavities of the button component without contacting the button component;
at least another one of the strain-based sensors is attached to a top surface of the second substrate and located within another corresponding one of the cavities of the button component without contacting the button component;
at least one of the mechanical switches is attached to a bottom surface of the first substrate, and at least another one of the mechanical switches is attached to a bottom surface of the second substrate; and
each of the mechanical switches sits on the bottom portion of the holding basket.

16. The button input structure of claim 4 wherein the button component has a hat configuration including a button body and a button rim, wherein:
the button body has a slightly smaller horizontal size than the opening to ensure that the button component is capable of moving vertically through the opening; and
the button rim protrudes horizontally from a bottom portion of the button body, has a larger horizontal size than the opening, and is located underneath the opening, so as to secure the button component in place.

17. The button input structure of claim 1 wherein a quantity of the mechanical switches and a quantity of the strain-based sensors are different.

18. The button input structure of claim 1 wherein a quantity of the mechanical switches and a quantity of the strain-based sensors are the same.

19. The button input structure of claim 1 wherein the mechanical switches and the strain-based sensors are located on a same surface of the at least one substrate.

20. The button input structure of claim 1 wherein the mechanical switches and the strain-based sensors are located on opposite surfaces of the at least one substrate.

21. A method of operations of an electronic device with a button input structure, which includes a button component, a substrate, mechanical switches, and strain-based sensors, comprising:
at least partially actuating the mechanical switches by depression of the button component, which is caused by an external force applied to the button component;
sensing strain on the substrate mechanically connected to the button component by the strain-based sensors, wherein the strain is caused by the depression of the button component from the external force applied to the button component;
providing an output by each of the strain-based sensors based on the sensed strain indicating information of an amount of the external force applied to the button component and a touch location of the external force applied to the button component;
determining the touch location of the external force applied to the button component based on the output of each of the strain-based sensors; and
calculating the amount of the external force applied to the button component based on the output of each of the strain-based sensors and the determined touch location of the external force.
